(19) United States
(12) Patent Application Publication
(10) Pub. No.: US 2010/0110727 A1
(43) Pub. Date: May 6, 2010

(54) Planar lighting device

(75) Inventor: Osamu Iwasaki, Shizuoka (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/588,935

(22) Filed: Nov. 3, 2009

(30) Foreign Application Priority Data
Nov. 4, 2008 (JP) 2008-283274

(51) Int. Cl. F21V 8/00; F21V 11/00

(52) U.S. Cl. 362/613; 362/618; 362/611

(57) ABSTRACT

A planar lighting device provided with a film in front of the light guide plate, wherein the film can be disposed independently of the light guide plate so that the film does not affect the expansion and contraction of the light guide plate while the expansion and contraction of the film are prevented from affecting the light guide plate. The planar lighting device includes a light guide plate, a light source unit, a film supporter and at least one sheet of film. The light guide plate includes a rectangular light exit plane and a light entrance plane existing one side of the light exit plate, the planar lighting device being installed with that one side being located above the opposite side. The light source is disposed opposite the light entrance plane. The sheet of film is suspended from a film supporter and disposed in front of the light exit plane.

The entire contents of the documents cited in this specification are incorporated herein by reference.

### BACKGROUND

The present invention relates to a planar lighting device used for a liquid crystal display device and the like.

Liquid crystal display devices use a backlight unit (planar lighting device) for radiating light from behind the liquid crystal display panel to illuminate the liquid crystal display panel. A backlight unit is configured using a light guide plate for diffusing light emitted by an illuminating light source to irradiate the liquid crystal display panel and optical parts such as a prism sheet and a diffusion sheet for rendering the light emitted from the light guide plate uniform.

Currently, large liquid crystal televisions predominantly use a so-called direct illumination type backlight unit comprising a light guide plate disposed immediately above the illuminating light source. This type of backlight unit comprises a plurality of cold cathode tubes serving as a light source provided behind the liquid crystal display panel whereas the inside of the backlight unit provides white reflection surfaces to ensure uniform light amount distribution and necessary brightness.

To achieve a uniform light amount distribution with a direct illumination type backlight unit, however, a thickness of about 30 mm in a direction perpendicular to the liquid crystal display panel is required, making further reduction of thickness difficult with the direct illumination type backlight unit.

Among backlight units that allow reduction of thickness thereof is a backlight unit using a light guide plate in which light emitted by an illumination light source and entering the light guide plate is guided in given directions and emitted through a light exit plane that is different from the plane through which light entered.

There has been proposed a backlight unit of a type using a light guide plate formed by mixing scattering particles for diffusing light into a transparent resin, wherein light is admitted through one or more end faces of the plate adapted to be light entrance planes and one of the largest planes is adapted to be the light exit plane.

JP 07-36037 A, for example, discloses a light diffusion light guide light source device comprising a light diffusion light guide member having at least one light entrance plane region and at least one light exit plane region and light source means for admitting light through the light entrance plane region, the light diffusion light guide member having a region that has a tendency to decrease in thickness with the increasing distance from the light entrance plane.

JP 08-248233 A discloses a planar light source device comprising a light diffusion light guide member, a prism sheet provided on the side of the light diffusion light guide member closer to a light exit plane, and a reflector provided on the rear side of the light diffusion light guide member. JP 08-271739 A discloses a liquid crystal display comprising a light emission direction correcting element formed of sheet optical materials provided with a light entrance plane having a repeated undulate pattern of prism arrays and a light exit plane given a light diffusing property. JP 11-153963 A discloses a light source device comprising a light diffusion light guide member having a scattering power therein and light supply means for supplying light through an end face of the light diffusion light guide member.

### SUMMARY OF THE INVENTION

Some of the backlight units using a light guide plate as described above may also use such films (sheets) as a prism sheet, a light diffusion sheet, and the like having various functions located in front of the light exit plane in order to render uniform the light emitted from the light exit plane of the light guide plate.

These films used for the backlight are generally fixed to the light guide plate or secured with a fixing means to a given position.

The light guide plate and these films are liable to expand and contract when heated or moistened. Thus, in the conventional backlight unit, the film prevents the light guide plate from expanding or contracting, or the light guide plate is affected by the expansion and contraction of the film, causing the light guide plate to warp or distort and making it impossible to emit appropriate illumination light. Even when only the film expands and contracts without affecting the light guide plate, the film cannot produce intended effects if the film warps or distorts, making it impossible to emit intended illumination light.

Further, when the light exit plane of the light guide plate touches the film, an interference fringe may be produced, which also makes it impossible to admit appropriate illumination light into the liquid crystal display panel.

While the light guide plate and the film are preferably disposed with a slight gap between them, the light guide plate and the film in the conventional backlight units as described above can come into contact with each other if the light guide plate and/or the film warps or distorts.

An object of the present invention is to solve the problems associated with the prior art and provide a planar lighting device used in, for example, the backlight unit of a liquid crystal display panel comprising a light source unit, a light guide plate, and a sheet or sheets of film disposed in front of the light exit plane of the light guide plate, wherein the sheet or sheets of film do not affect the expansion and contraction of the light guide plate due to moisture absorption and heating, expansion and contraction of the light guide plate due to moisture absorption and heating do not affect the light guide plate, distortion and warping of the light guide plate and the film can be prevented in an optimum manner, and the contact between the light guide plate and the film that might otherwise be caused by this can be prevented.

To solve the above problems, the invention provides a planar lighting device comprising a light guide plate comprising a rectangular light exit plane and a light entrance plane existing on one side of the light exit plate, the one side being located above the opposite side; a light source unit disposed opposite the light entrance plane; a film support means provided with the light guide plate; and at least one sheet of film suspended from and supported by the film support means and disposed in front of the light exit plane.

In such a planar lighting device, the at least one sheet of film is preferably suspended from the film support means using long holes formed in one of the at least one sheet of film and the film support means and oriented in a normal direction normal to an up-and-down direction of the light guide plate and pins formed on the other and inserted into the long holes, respectively.

Preferably, the planar lighting device further comprises a film securing means on a center line of the at least one sheet of film in a normal direction normal to an up-and-down direction for preventing displacement of the at least one sheet of film in the normal direction.

Preferably, the planar lighting device further comprises a light source support means supporting the light source unit, wherein the light source unit is suspended from the light source support means.

Preferably, the light source unit is suspended from the light source support means using long holes formed in one of the light source unit and the light source support means and oriented in a normal direction normal to an up-and-down direction and pins formed on the other and inserted into the long holes, respectively.

Preferably, the planar lighting comprises a light source securing means on a center line of the light source unit in a normal direction normal to an up-and-down direction for preventing displacement of the light source unit in the normal direction.

Preferably, the gap between the light exit plane and one of the at least one sheet of film closest to the light exit plane is in a range of 0.05 mm to 0.2 mm.

Preferably, the at least one sheet of film has sheets of film, and a gap between adjacent two sheets of film is in a range of 0.05 mm to 0.2 mm.

Preferably, the planar lighting device further comprises another light source unit, wherein the light guide plate comprises another light entrance plane existing on the opposite side of the light exit plate, and the another light source unit is disposed opposite the another light entrance plane.

Preferably, the thickness of the light guide plate gradually increases with an increasing distance from the light entrance plane.

Preferably, the light source unit comprises a plate-like portion disposed so as to cover a plane located opposite from the light exit plane of the light guide plate.

Preferably, the length of the plate-like portion in a direction away from the light source unit is set to a maximum possible length with the plate-like portion located closest possible to the light exit plane depending upon a shape of the light source unit instead of away from the rear side opposite from the light exit plane of the light guide plate.

According to the invention providing the above configuration, the prism sheet, the diffusion sheet, etc., although held by the film support means provided on the light guide plate, are so held that they are suspended (hang) from the film support means. Thus, the light guide plate and the film are disposed in the same manner as when they are disposed totally independently of each other.

Thus, even when the light guide plate and the film expand and contract when heated or moistened, they do not affect each other. In addition, since the film is supported by hanging, the warping and distortion of the light guide plate and the film caused by the expansion and contraction can be prevented. Further, since the warping and distortion of the film can be prevented, the contact between the light exit plane of the light guide plate and the film that might otherwise be caused by such warping and distortion can be prevented. In addition, the film can be supported with the gaps between the film and the light guide plate and between the films maintained to an appropriate distance by a simple configuration where the film is merely suspended from the film support means provided on the light guide plate.

### BRIEF DESCRIPTION OF THE DRAWINGS

FIG. 1 is a schematic perspective view illustrating an example of a liquid crystal display device using the planar lighting device of the invention.

FIG. 2A is a schematic front view of the backlight unit of the liquid crystal display device illustrated in FIG. 1; FIG. 2B is a cross section taken along line I-I of FIG. 2A; FIG. 2C is a cross section taken along line II-II of FIG. 2A.

FIG. 3A is a schematic perspective of the light guide plate of the backlight unit illustrated in FIG. 2; FIG. 2B is schematic side view.

FIG. 4A is a partial perspective of a light source unit of the backlight unit illustrated in FIG. 2; FIG. 4B is a partial perspective of an LED chip; and FIG. 4C is a partial schematic front view of the light source unit.

FIGS. 5A and 5B are views representing a concept of a film used for the backlight unit illustrated in FIG. 2.

FIG. 6 is a schematic front view of another example of the backlight unit according to the planar lighting device of the invention.

FIG. 7A is a schematic side view of the light source of the backlight unit illustrated in FIG. 6; FIG. 7B is a schematic front view of a guide member used in the backlight unit; FIG. 7C is a schematic side view thereof.

FIG. 8 is a partial schematic side view of another example of the backlight unit according to the planar lighting device of the invention.

### DETAILED DESCRIPTION OF THE INVENTION

Now, the planar lighting device of the invention will be described in detail referring to preferred embodiments illustrated in the accompanying drawings.

While the planar lighting device described below as a representative examples is a two-light entrance plane type whereby light from two light source units is admitted through two light entrance planes existing two sides of the light guide plate, respectively, the example is not limitative of the scope of the present invention.

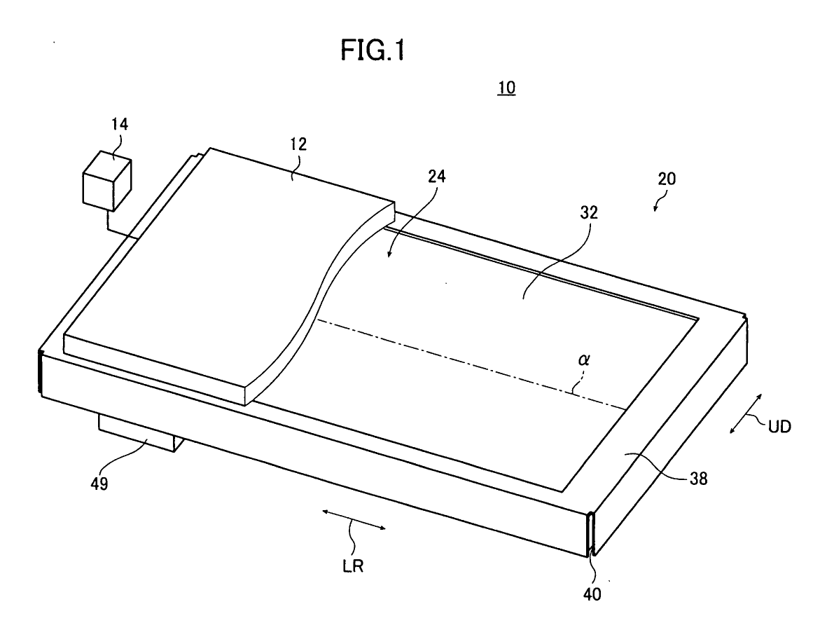

FIG. 1 is a schematic perspective view illustrating an example of a liquid crystal display device using the planar lighting device of the invention.

A liquid crystal display device 10 illustrated in FIG. 1 is a display device such as a liquid crystal television using a so-called liquid crystal display panel (LCD) 12 and basically comprises a liquid crystal display panel 12, a backlight unit 20 according to the planar lighting device of the invention, and a drive unit 14 for driving the liquid crystal display panel 12.

The liquid crystal display device 10 is basically installed so that the longer sides of the liquid crystal display panel 12 having a rectangular image display plane (viewing surface) are positioned one above the other vertically. The backlight unit 20 is disposed behind the liquid crystal display panel 12 (on the opposite side from the image display plane), with the light exit plane directed toward the liquid crystal display panel 12. In the description to follow, the vertical direction in which the shorter sides of the liquid crystal display panel 12 (light guide plate 30 described later) extend, i.e., the vertical direction of the liquid crystal display panel 12 as correctly installed, will be referred to also as up-and-down (UD) direction, and the direction in which the longer sides of the liquid crystal display panel 12 extend, i.e., the horizontal direction normal to the up-and-down (vertical) direction, will be referred to also as left-and-right (LR) direction for the purpose of the invention.

In FIG. 1, a part of the liquid crystal display panel 12 is not shown to better illustrate the configuration of the backlight unit 20.

In the liquid crystal display panel 12, an electric field is partially applied to liquid crystal molecules, previously arranged in a given direction, to change the orientation of the molecules. The resultant changes in refractive index in the liquid crystal cells are used to display characters, figures, images, etc., on the liquid crystal display panel 12.

The drive unit 14 applies a voltage to transparent electrodes in the liquid crystal display panel 12 to change the orientation of the liquid crystal molecules, thereby controlling the transmittance of the light transmitted through the liquid crystal display panel 12.

The backlight unit 20 is a lighting device for illuminating the whole surface of the liquid crystal display panel 12 from behind the liquid crystal display panel 12 and comprises a light exit opening 24 having substantially a same shape as the image display plane of the liquid crystal display panel 12.

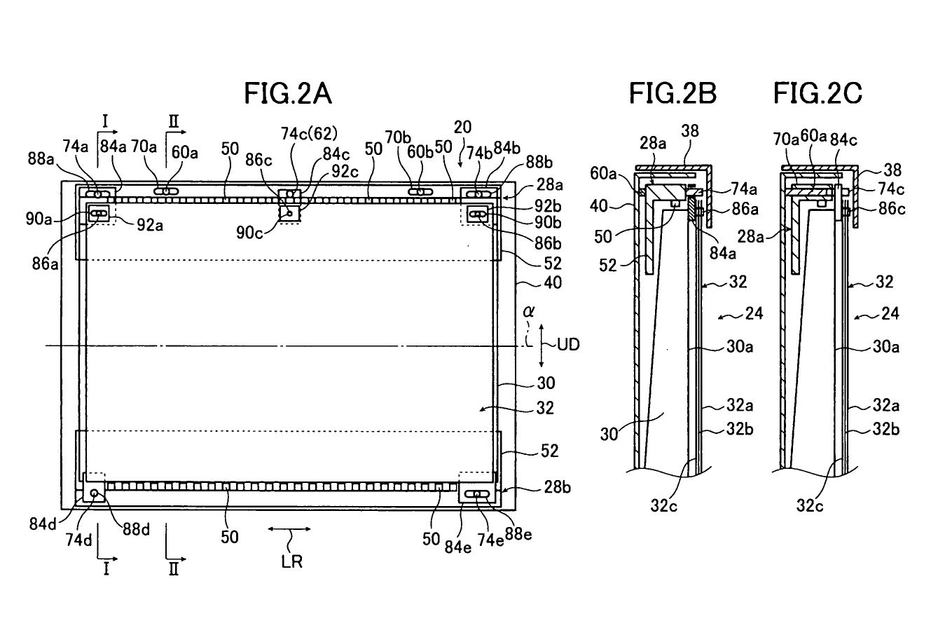

As illustrated in FIGS. 1 and 2, the illustrated example of the backlight unit 20 comprises two light source units 28 (28a and 28b), a light guide plate 30, three sheets of films 32 (32a, 32b, and 32c), a reflection plate 34, an upper housing 38, and a lower housing 40.

FIG. 2A is a view representing the concept of the front side (the display side of the liquid crystal display panel 12) of the backlight unit 20 with the upper housing 38 removed; FIG. 2B is a cross section taken along line I-I of the backlight unit 20 of FIG. 2A; FIG. 2C is a cross section taken along line II-II of FIG. 2A.

The lower housing 40 is a housing in the form of a rectangular solid opening on one side (the largest plane) and accommodates/holds the two light source units 28, the light guide plate 30 comprising a rectangular light exit plane, the three sheets of films 32, and the reflection plate 34 in their given positions. The light guide plate 30 is encased in the lower housing 40, with the light exit plane 30a described later directed toward the opening side. A power unit casing 49 is provided on the rear side of the lower housing 40 to house power supply units that supply the light source units 28 with electrical power.

The upper housing 38 has the same shape as the lower housing 40 so that the lower housing 40 may be inserted into it as into a lid. The upper housing 38 is formed in its plane facing the opening with the light exit opening 24 for irradiating the rear side of the liquid crystal display panel 12 with light emitted from the light guide plate 30.

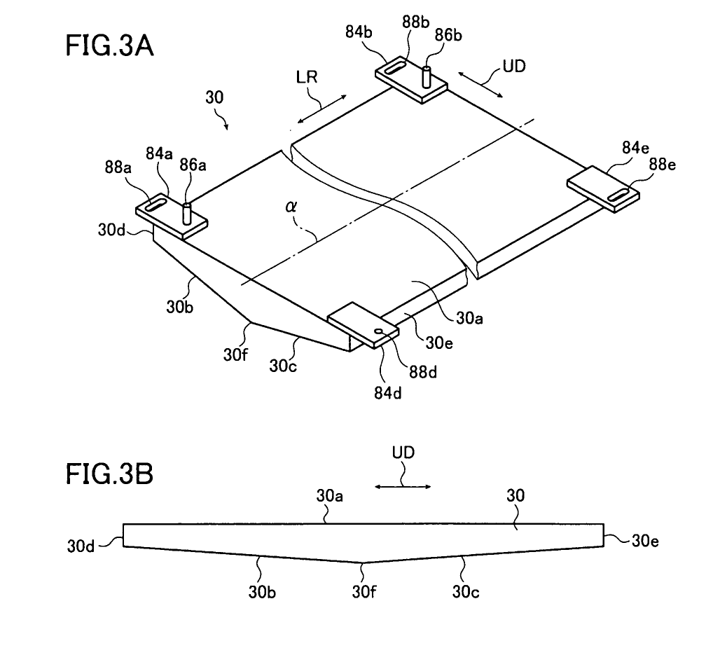

FIG. 3 represents a concept of the light guide plate 30. FIG. 3A is a perspective; FIG. 3B is a schematic side view (as seen from the direction normal to the shorter sides).

As illustrated in FIG. 3, the light guide plate 30 is a plate member having a rectangular light exit plane 30a that can contain the whole surface of the light exit opening 24 and be accommodated in the lower housing. The light guide plate 30 comprises the light exit plane 30a, inclined planes 30b and 30c located on the opposite side from the light exit plane 30a, and light entrance planes 30d and 30e being the end faces on the longer sides of the light exit plane. The light entrance planes 30d and 30 are rectangles having exactly the same shape and have the same thickness (dimension in the direction normal to the light exit plane).

As described above, the liquid crystal display device 10 is installed with one longer side located above the other or, in other words, in such a posture that the longer sides extend in the left-and-right direction. Accordingly, the light guide plate is installed so that the light entrance planes 30d and 30e, the longer sides, are also installed with one located above the other. In the illustrated example, the light entrance plane 30d is located in the upper position by way of example.

In the illustrated example representing a preferred embodiment, the light guide plate 30 is thickest on the rear side in a position corresponding to a ridge line 30f, which is parallel to a center line α, a bisector of the rectangular light exit plane 30a in the up-and-down direction (i.e., a bisector of the shorter sides), that is, thickest in a plane normal to the light exit plane 30a and passing through the center line α. Accordingly, the inclined plane 30b is a rear plane, which is a flat plane inclined with respect to the light exit plane 30a and connects the ridge line 30f and the side of the light entrance plane 30d closer to the rear side; the inclined plane 30c is a rear plane which is a flat plane inclined with respect to the light exit plane 30a and connects the ridge line 30f and the side of the light entrance plane 30e closer to the rear side.

The light entrance planes 30d and 30e, having the same thickness, are symmetrical with respect to the inclined planes 30b and 30c, the center line α, and the ridge line 30f. Accordingly, as illustrated in FIG. 3B, the light guide plate 30 has a configuration such that it gradually grows thicker with the increasing distance from the light entrance planes 30d and 30e, becoming the thickest at the ridge line 30f corresponding to the center line α (the configuration being referred to as “wedge shape” below for the purpose of the invention).

The joint at the ridge line 30f between the inclined planes 30b and 30c is not limited to a joint where two flat planes meet; the otherwise flat planes may be curved close to the ridge line 30f.

In the illustrated example, light is admitted through the two light entrance planes 30d and 30e, propagates in the light guide plate 30 in the direction parallel to the shorter sides, and passes through the light exit plane 30a to illuminate the rear side of the liquid crystal display panel 12.

There is no specific limitation to the thickness of the light entrance planes. If the light entrance planes are too thin, a sufficient amount of light cannot be admitted, and thus the light having a sufficient brightness cannot be emitted. Conversely, too thick light entrance planes add to the whole weight of the light guide plate, making the light guide plate unfit as an optical member of the liquid crystal display device and the like while reducing the light use efficiency as the light is allowed to easily pass through the light guide plate. Taking the above into consideration, the thickness of the light entrance planes 30d and 30e is preferably in a range of 0.5 mm to 3.0 mm.

The thickness at the ridge line 30f (thickness at the center of the light guide plate 30 in the propagating direction) is also not limited. If the thickness at the ridge line 30f is too great, the weight increases, making the light guide plate unfit as an optical member of the liquid crystal display device and the like, while reducing the light use efficiency as the light is allowed to easily pass through the light guide plate. Conversely, if the thickness there is too small, not only is shaping difficult, the effects to be produced by the wedge shape cannot be obtained sufficiently. Taking the above into consideration, the thickness of the light guide plate at the ridge line 30f is preferably in a range of 1.0 mm to 6.0 mm.

As in the illustrated example, the light guide plate 30, shaped such that its thickness increases with the increasing distance from the light entrance planes makes it easier for the incoming light to travel still deeper into the light guide plate (in the direction away from the light entrance planes), thus improving the in-plane uniformity while maintaining the light use efficiency and further achieving a high-in-the-middle, bell-curve brightness distribution. In other words, such a shape achieves a uniform or a high-in-the-middle, bell-curve distribution where the conventional, flat light guide plate could only provide a distribution that is dark in the middle.

The light guide plate 30 preferably has fine scattering particles for scattering light therein and may be formed, for example, by extrusion molding or injection molding using a transparent resin into which scattering particles are kneaded and dispersed.

Transparent resin materials that may be used to form the light guide plate 30 include optically transparent resins such as PET (polyethylene terephthalate), PP (polypropylene), PC (polycarbonate), PMMA (polymethyl methacrylate), benzyl methacrylate, MS resins, and COP (cycloolefin polymer).

The scattering particles kneaded and dispersed into the light guide plate 30 are exemplified by TOSPEARL (trademark), silicone, silica, zirconia, and a derivative polymer. The light guide plate 30 containing such scattering particles is capable of emitting uniform illumination light through the light exit plane 30a with a greatly reduced level of brightness unevenness.

The diameter of the scattering particles dispersed in the light guide plate 30 used in the planar lighting device of the invention preferably is in a range of 4.0 μm to 12.0 μm both inclusive. The diameter of the scattering particles within that range is preferable as it permits achieving a high scattering efficiency, a great forward scattering property, and a small wavelength dependency, and optimally reduces uneven color representation.

The scattering particles used may have a single particle diameter, or scattering particles having a plurality of diameters may be mixed and used.

In the light guide plate 30, the higher the light use efficiency is, the more preferable. This is because given a low light use efficiency, a light source capable of generating a greater output is needed to obtain a required brightness, and a light source capable of generating a greater output not only assumes a higher temperature and consumes a greater amount of electricity but also causes the light guide plate 30 to warp or expand considerably, making it impossible to achieve a required brightness distribution, i.e., a high-in-the-middle or bell-curve brightness distribution. Taking the above into consideration, the light use efficiency of the light guide plate is preferably 55% or more.

Further, thin, large-screen liquid crystal televisions require a high-in-the-middle (bell-curve) brightness distribution, wherein the area closer to the center of the screen is brighter than the periphery. Therefore, the light guide plate 30 preferably yields a brightness distribution in the light exit plane 30a such that the middle-high ratio, which represents a ratio of the brightness of the light emitted through the central area to the brightness of the light emitted through the areas closer to the light entrance planes, is in a range of 0% to 25% inclusive.

In the light guide plate 30, at least one plane of the light entrance planes 30d and 30e, the light exit plane 30a, and the inclined planes 30b and 30c, which act as light reflection planes, preferably has a surface roughness Ra of less than 380 nm.

When the light entrance planes have a surface roughness Ra of less than 380 nm, diffuse reflection on the surfaces of the light guide plate can be ignored or, in other words, diffuse reflection on the surfaces of the light entrance planes can be prevented and, thus, light admission efficiency can be improved. Further, when the light exit plane 30a is given a surface roughness Ra of less than 380 nm, transmission by diffuse reflection through the surface of the light guide plate can be ignored or, in other words, transmission by diffuse reflection on the surface of the light guide plate can be prevented and, therefore, light is allowed to travel further deep into the light guide plate by total reflection. Further, when the reflection planes are given a surface roughness Ra of less than 380 nm, diffuse reflection can be ignored or, in other words, diffuse reflection on these reflection planes can be prevented and, therefore, all the reflected light components are allowed to travel further deep into the light guide plate.

In the backlight unit 20 of the invention, a reflection plate for reflecting light toward the light guide plate 30 is preferably provided where necessary such as in the inclined planes 30b and 30c acting as light reflection planes, as in known light guide plates. Provision of a reflection plate improves the light use efficiency.

The reflection plate may be formed of any material as appropriate used for light guide plates including, for example, a resin sheet produced by kneading, for example, PET or PP (polypropylene) with a filler and then drawing the resultant mixture to form voids therein for increased reflectance; a sheet with a specular surface formed by, for example, depositing aluminum vapor on the surface of a transparent or white resin sheet; a metal foil such as an aluminum foil or a resin sheet carrying a metal foil; and a thin sheet metal having a sufficient reflective property on the surface.

As will be described, support members 84a to 84e are secured to the four corners and the center in the left-and-right direction of the upper side of the light exit plane 30a of the light guide plate 30 to suspend the light guide plate 30 and the films 32 described later from the light source units 28 (the light source supports 52) described later. FIG. 3A does not show the support member 84c provided at the center in the left-and-right direction of the upper side. FIG. 3B does not show the support members 84a to 84e.

This will be described later in detail.

The support members 84a to 84e may be secured to the light guide plate 30 by any method, and any of the known methods may be used according to the material and shape of the light guide plate 30 and the support members. A method using an adhesive is preferable, however, in that no holes need be made and hence breaking or otherwise damaging the light guide plate 30 can be avoided.

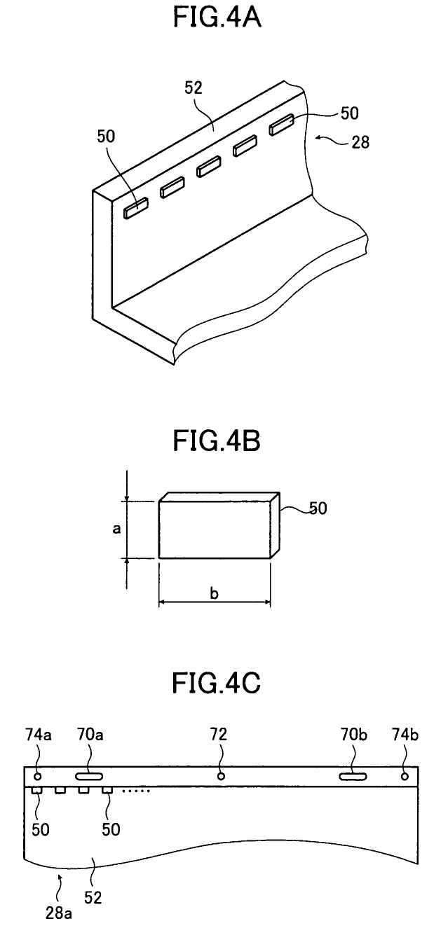

FIG. 4A is a schematic perspective illustrating a part (near an end portion in the left-and-right direction) of the light source unit (hereinafter also referred to as “light source”) 28.

As illustrated in FIG. 4A, the light source 28 comprises a plurality of LED chips (light emitting diodes) 50 and a light source mount 52 such that the LED chips 50 are arranged on the light source mount 52.

Each LED chip 50 is a chip of a light emitting diode emitting blue light the surface of which has a fluorescent substance applied thereon. It has a given area of light emission face 58 for emitting white light.

Specifically, the LED chip 50 has a property of generating fluorescence as blue light emitted by the light emitting diode is transmitted through the fluorescent substance applied to the surface of the light emitting diode. Thus, when blue light is emitted from the light emitting diode, the fluorescent substance through which the blue light is transmitted also generates light so that the blue light emitted by the light emitting diode and transmitted through the fluorescent substance and the light emitted as the fluorescent substance generates fluorescence blend to produce and emit white light.

The LED chip 50 may for example be formed by applying a YAG (yttrium aluminum garnet) base fluorescent substance to the surface of a GaN base light emitting diode, an InGaN base light emitting diode, and the like.

Besides the LED chips 50, the light source 28 of the planar lighting device of the invention may use various light emitting devices that can be applied to the planar lighting device.

For example, in the case of the liquid crystal display device 10 as illustrated by way of example, an LED unit formed using three kinds of LEDs, i.e., a red LED, a green LED, and a blue LED, may be used. Alternatively, a semiconductor laser (LD) may be used instead of an LED.

A light source support 52 is a long plate member having an L-shaped side elevation (cross section) formed by joining two long plates at right angles on longitudinal sides thereof.

In the illustrated example, the LED chips 50 are arranged at given intervals on the surface of the shorter side of the L-shaped configuration of the light source support 52. The light source support 52 comprises a circuit board (not shown) for driving the LED chips 50.

The light source 28a is disposed with the L-shaped configuration inverted upside down so that the surface bearing the LED chips 50 faces the light entrance plane 30d of the light guide plate 30 whereas the longer side of the L-shaped configuration faces the inclined plane 30b of the light guide plate 30 and that the light source 28a extends in the left-and-right direction of the light guide plate 30 to have the LED chips 50 face the light entrance plane 30d.

The light source 28b is likewise disposed so that the surface bearing the LED chips 50 faces the light entrance plane 30e of the light guide plate 30 whereas the longer side of the L-shaped configuration faces the inclined plane 30c of the light guide plate 30. Thus, light is admitted through the light entrance plane 30d or 30e and propagates in the light guide plate 30 to be emitted through the light exit plane 30a.

As illustrated in FIG. 4B, the illustrated example of the LED chips 50 have a rectangular shape such that their sides perpendicular to the direction in which the LED chips 50 are arrayed are shorter than their sides lying in the direction in which the LED chips 40 are arrayed or, in other words, their sides lying in the direction of thickness of the light guide plate 30 are the shorter sides. Expressed otherwise, the LED chips 50 each have a shape defined by b>a where “a” denotes the length of the side perpendicular to the light exit plane 30a of the light guide plate 30 and “b” denotes the length of the side in the array direction.

Now, given “q” as the distance by which the arrayed LED chips 50 are spaced apart from each other, then q>b holds. Thus, the length “a” of the side of the LED chips 50 perpendicular to the light exit plane 30a of the light guide plate 30, the length “b” of the side in the array direction, and the distance “q” by which the arrayed LED chips 50 are spaced apart from each other preferably have a relationship satisfying q>b>a.

Providing the LED chips 50 each having the shape of a rectangle allows a thinner design of the light source to be achieved while producing a large amount of light. A thinner light source, in turn, enables a thinner design of the planar lighting device to be achieved. Further, the number of LED chips that need to be arranged may be reduced.

While the LED chips 50 each preferably have a rectangular shape with the shorter sides lying in the direction of the thickness of the light guide plate 30 for a thinner design of the light source, the present invention is not limited thereto, allowing the LED chips to have any shape as appropriate such as a square, a circle, a polygon, and an ellipse.

In the illustrated example, the LED chips 50 are arrayed in a single row but the invention is not limited this way; the LED chips 50 may be arrayed in a plurality of rows.

As schematically illustrated in FIG. 4C, the light source support 52 of the upper light source 28a is provided through its plate bearing the LED chips 50 arrayed thereon with long holes 70a and 70b through which pins 60a and 60b of the lower housing 40 described later are passed and a through-hole 72 through which a support pin 62 of the lower housing 40 is passed. The light source support 52 further has support pins 74a and 74b secured thereto close to both ends thereof in the left-and-right direction for supporting support members 84a and 84b of the light guide plate 30 described later.

As illustrated in FIG. 2A, the lower light source 28b has secured thereto support pins 74d and 74e, which engage with the support members 84d and 84e secured to the light guide plate 30.

This will be described later in detail.

As illustrated in FIGS. 2B and 2C, three sheets of films 32 (32a, 32b, and 32c) are disposed in front of the light guide plate 30 (the light exit plane 30a).

In the illustrated example, the film 32a is a diffusion sheet to diffuse the illumination light emitted through the light guide plate 30 (the light exit plane 30a) to reduce brightness unevenness. The film 32b is a prism sheet having micro prism arrays formed thereon. The film 32c is a diffusion sheet to diffuse the illumination light emitted through the film 32b (prism sheet) to reduce brightness unevenness. The prism sheet being the film 32b is disposed so that the ridge lines of the micro prism arrays lie parallel to the center line α (in the left-and-right direction).

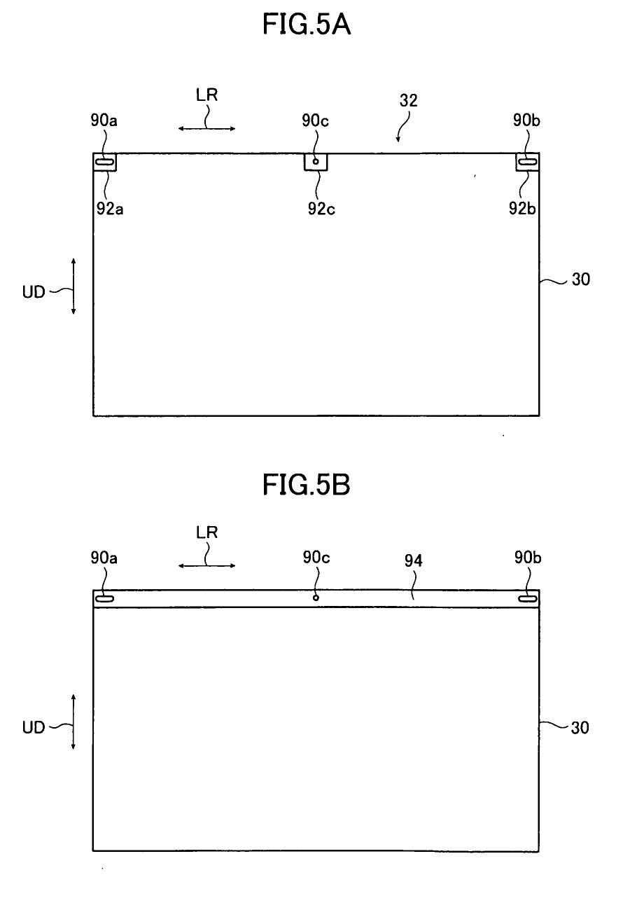

The films 32 have long holes 90a and 90b and a through-hole 90c through which support pins 86a, 86b and 86c secured to the support members 84a, 84b, and 84c are passed (see FIG. 5A).

The diffusion sheets and the prism sheet may be any known diffusion sheets and a known prism sheet. The sheets described in paragraphs [0028] through [0033] of JP 2005-234397 A by the Applicant of the present application may be cited as preferred examples.

While in the illustrated example, the backlight unit 20 uses the films 32 composed of two diffusion sheets (30a and 30c) and a prism sheet (30b) disposed between them, there is no limitation according to the invention to the order in which the films are disposed and the number in which they are provided.

These films are not limited to a prism sheet and diffusion sheets and various optical films may be used provided that they can reduce brightness unevenness of the illumination light emitted through the light exit plane 30a of the light guide plate 30. For example, one may use optical films formed of transmittance adjusting films each comprising a number of transmittance adjusters consisting of diffusion reflectors distributed according to the brightness unevenness in addition to or in place of the diffusion sheets and the prism sheet described above. Besides these, one may use various films having a variety of functions that are used for backlight units (planar lighting devices).

In the backlight unit 20 according to the illustrated example, the upper light source 28a is suspended from the lower housing 40, the light guide plate 30 is suspended from the light source 28a, and the films 32 and the lower light source 28b are suspended from the light guide plate 30.

Now, their configuration will be described referring to FIGS. 2, 3, and 5A.

A support pin 62 is erected on the inner wall surface on the rear side of the lower housing 40 at the center in the left-and-right direction (LR). A support pin 60a is erected in the same position in the up-and-down (UD) direction as the support pin 62 but spaced a given distance toward one side in the left-and-right direction from the support pin 62, and a support pin 60b is likewise erected in a position spaced the same distance toward the other side.

As described earlier, the light source support 52 of the upper light source 28a has a through-hole 72 located at the center in the left-and-right direction of the plate member bearing the LED chips 50 and formed through the plate member in the direction of thickness of the light guide plate 30. Further, the light source support 52 has a long hole 70a, also a through-hole, oriented in the left-and-right direction and spaced a given distance toward one side in the left-and-right direction from the through-hole 72 and a similar long hole 70b oriented in the left-and-right direction spaced the same distance toward the other side. Both long holes 70a and 70b are formed such that the distance from the center of the through-hole 72 to the center in the left-and-right direction of these holes is equal to the distance between the support pin 62 and the support pins 60a and 60b.

In the backlight unit 20 according to the illustrated example, the support pin 62 of the lower housing 40 is inserted into the through-hole 72 of the light source 28a, the support pin 60a of the lower housing 40 is inserted into the long hole 70a of the light source 28a, and the support pin 60b of the lower housing 40 is inserted into the long hole 70b of the light source 28a so that the lower housing 40 supports the light source 28a in a given position.

The backlight unit 20 is disposed so that the shorter sides of the light guide plate 30 lie in the up-and-down direction (the longer sides being aligned one above the other). Thus, the light source 28a, located above the light guide plate 30, is supported so as to hang from the lower housing 40.

The light source support 52 of the light source 28a has a support pin 74a erected on the end face on the front side of the plate member bearing the LED chips 50 arrayed thereon close to one end in the left-and-right direction and a support pin 74b erected at the same position in the up-and-down direction but close to the other end. A support pin 74c is erected in the same position in the up-and-down direction as the support pin 74, etc. but at the center in the left-and-right direction.

As described above, the support members 84a, 84b, 84d, and 84e are secured to the four corners of the light exit plane 30a of the light guide plate 30. The support members 84a, 84b are secured to the upper side; the support members 84d, 84e are secured to the lower side. The support member 84c is secured to the upper side at the center thereof in the left-and-right direction.

The support members 84a and 84b secured to the end portions in the left-and-right direction of the upper side of the light guide plate 30 each have long holes 88a and 88b, respectively, which, both a through-hole, are formed at the same position in the up-and-down direction thereof and oriented in the left-and-right direction. Both long holes 88a and 88b are formed such that the distance from the center of the light guide plate 30 to the center in the left-and-right direction of these holes (long holes) is equal to the distance between the through-hole 72 and the support pins 74a, 74b formed in the light source support 52.

The support member 84c secured to the upper side at the center thereof has a through-hole 88c at the same position in the up-and-down direction as the above long hole 88a, etc. but at the center in the left-and-right direction of the light guide plate 30.

In the backlight unit 20 according to the illustrated example, the support pin 74c of the light source support 52 of the light source 28a is inserted into the through-hole 88c, the support pin 74a of the light source 28a is inserted into the long hole 88a of the support member 84a, and the support pin 74b of the light source 28a is inserted into the long hole 88b of the support member 84b.

Thus, the light guide plate 30 is so supported by the light source 28a (the light source support 52 thereof), with the former suspended from the latter, that the light entrance plane 30d of the light guide plate 30 faces the LED chips 50. Needless to say, the relative positions in the up-and-down direction of the support pins and the respective support members are set so that the distance between the light source 28a (the light emission face of the LED chips 50) and the light entrance plane 30d is appropriate.

The support member 84a secured to the light guide plate 30 has the support pin 86a erected thereon, the support member 84b has the support pin 86b erected thereon, and the support member 84c located at the center in the left-and-right direction has the support pin 86c erected thereon.

As illustrated in FIG. 5A, a reinforcing member 92a is secured to the upper side of the films 32 at one end thereof in the left-and-right direction, a reinforcing member 92b is secured at the other end, and a reinforcing member 92c is secured at the center in the left-and-right direction.

The reinforcing members 92a and 92b each have long through-holes 90a and 90b, respectively, which are formed at the same position in the up-and-down direction and oriented in the left-and-right direction. (The through-holes 90a and 90b are formed also through the film 32.). Both long holes 90a and 90b are formed such that the distance from the center of the light guide plate 30 to the center in the left-and-right direction of these holes (long holes) is equal to the distance between the support pin 86c of the support member 84c of the light guide plate 30 and the through-hole 72 formed in the light source support 52 on the one hand and the support pin 86a of the support member 84a and the support pin 86b of the support member 84b on the other hand. The reinforcing member 92c located at the center in the left-and-right direction has a through-hole 90c (same as above) at the same position in the up-and-down direction as the support pins 86a, etc. but at the center in the left-and-right direction.

In the backlight unit 20 according to the illustrated example, the support pin 86c of the support member 84c secured to the light guide plate 30 is inserted into the through-hole 90c of the reinforcing member 92c, the support pin 86a of the support member 84a is inserted into the through-hole 90a of the reinforcing member 92a, and the support pin 86b of the support member 84b is inserted into the through-hole 90b of the reinforcing member 92b.

Thus, the films 32 are supported by the light guide plate 30 with the former suspended from the latter.

As described above, the support members 84d and 84e are secured to the lower side of the light guide plate 30 at both ends thereof in the left-and-right direction. The support member 84d has a through-hole 88d and the support member 84e has a long through-hole 88e that is formed at the same position in the up-and-down direction as the through-hole 88d and oriented in the left-and-right direction.

In the light source support 52 of the lower light source 28b, support pins 74d and 74e are secured to the end face on the front side of the plate member bearing the LED chips 50 arrayed thereon. The support pin 74d is secured at a position spaced the same distance from the center in the left-and-right direction as the through-hole 88d of the support member 84d and also spaced the same distance from the center in the left-and-right direction as the center in the left-and-right direction of the long hole 88e of the support member 84e.

In the backlight unit 20 according to the illustrated example, the support pin 74d of the lower light source 28b is inserted into the through-hole 88d of the support member 84d secured to the light guide plate 30, and the support pin 74d of the lower light source 28b is inserted into the long hole 88e of the support member 84e.

Thus, the light source 28a is so supported by the light guide plate 30, with the former suspended from the latter, that the light entrance plane 30e of the light guide plate 30 faces the LED chips 50 of the light source 28b. Needless to say, the relative positions in the up-and-down direction of the support pins and the respective support members are set so that the distance between the light source 28b (the light emission face of the LED chips 50) and the light entrance plane 30e is appropriate.

As will be apparent from the foregoing, in the backlight unit 20, the upper light source 28a is supported by the lower housing 40 with the former suspended from the latter, the light guide plate 30 is supported by the light source 28a with the former suspended from the latter, and the films 32 and the lower light source 28b are supported by the light guide plate 30 with the former suspended from the latter, thereby disposing these components in their given positions inside the lower housing 40.

In the backlight unit 20, the heat of the light sources 28, the moisture produced in the environments in which the backlight unit 20 is installed, and the like cause the light guide plate 30 and the films 32 to expand and contract.

In the conventional backlight units (planar lighting devices), the film is secured to the light guide plate and the support members. Accordingly, the film affects the expansion and contraction of the light guide plate, and the expansion and contraction of the film itself affect the light guide plate, leading to the expansion and contraction of the light guide plate caused by the film whereas the distortion of the film brings it into contact with the light guide plate.

According to the backlight unit 20 of the invention, however, the light guide plate 30 and the films 32 can be disposed with respect to each other in the same manner as if they were totally independent of each other in the up-and-down direction. This is achieved by disposing the films 32 suspended in a given position by a film support means secured to the light guide plate 30.

Thus, even when the light guide plate 30 and the films 32 expand and contract, they do not affect each other. In addition, because of the support by suspension, the warping or distortion of the films 32 caused by the expansion and contraction in particular in the up-and-down direction can be prevented. Further, since the warping and distortion of the films 32 can be prevented, the contact between the light guide plate 30 and the films 32 can be prevented. In addition, the film can be supported with the gaps between the films 32 and the light guide plate 30 and between the films themselves appropriately maintained by a simple configuration where the films are solely suspended from the film support means provided on the light guide plate 30.

Further, the films 32 disposed in front of the light guide plate 30 act as a moisture prevention member for the light guide plate 30 because the films 32 obstruct the opening of the upper housing 38 for the light guide plate 30. Thus, according to the invention, the expansion and contraction of the light guide plate 30 due to moisture absorption can be greatly curbed, and the warping and distortion of the light guide plate 30 due to moisture absorption can also be greatly curbed.

Further, in the illustrated example, also the light guide plate 30 is disposed so that it is suspended from the upper light source 28a whereas the lower light source 28b is disposed so that it is suspended from the light guide plate 30 as a preferred embodiment. Thus, the light guide plate 30 itself can be prevented from warping and distorting.

The present invention is not limited to such a configuration, however. The light guide plate 30 and/or the lower light source 28b may be fixedly disposed using a known fixing means.

Although, in the illustrated example, the independent reinforcing members 92a, 92b, and 92c are provided at both ends and at the center in the left-and-right direction of the upper side of the films 32 as illustrated in FIG. 5A, the invention is not limited to such a configuration.

For example, as illustrated in FIG. 5B, one may provide a single reinforcing member 94 extending in the left-and-right direction of the upper side of the films 32 having long holes 90a and 90b and a through-hole 90c formed at both ends and at the center in the left-and-right direction of this reinforcing member.

In the backlight unit 20 of the invention, there is no specific limitation to the gap between the light exit plane 30a of the light guide plate 30 and the sheet of the films 32 closest to the light guide plate 30 but the gap is preferably in a range of 0.05 mm to 0.2 mm. When the distance between them is in that range, the films 32 can optimally produce their optical properties, and the moisture prevention effect for the light guide plate 30 can be produced in a more preferable manner.

There is also no specific limitation to the gaps between the films 32 themselves but the gaps are preferably in a range of 0.05 mm to 0.2 mm. When the distances between the films 32 are in that range, the films 32 can optimally produce their optical properties, and the moisture prevention effect for the light guide plate 30 can be produced in a more preferable manner.

In the present invention, the gap between the light exit plane 30a and the films 32 and the gap between the films 32 themselves may be maintained each to an appropriate distance by, for example, forming a groove in the support pins, providing spacers such as washers between them, and the like.

In the backlight unit 20 according to the illustrated example, the engagement of the light guide plate 30 and the films 32 is achieved by means of the long holes that are oriented in the left-and-right direction and the support pins. This configuration permits absorbing the expansion and contraction of the light guide plate 30 and the films 32 in not only the up-and-down direction but also the left-and-right direction and preventing distortion and warping of the light guide plate 30 and the film 32 caused by the expansion and contraction in the left-and-right direction.

This also applies to the relationship between the lower housing 40 and the upper light source 28a, the upper light source 28a and the light guide plate 30, and the light guide plate 30 and the lower light source 28b.

In the illustrated example, the support pin 86c is erected at the center in the left-and-right direction of the light guide plate 30, and the through-hole 90c having about the same size as the support pin 86c (the through-hole 90c is larger only by a dimension for allowing the support pin 86c to pass therethrough) is formed at the center in the left-and-right direction of the films 32 whereby the support pin 86c is inserted into the through-hole 90c as a preferred embodiment.

Fixedly positioning the center in the left-and-right direction with respect to the left-and-right direction permits distribution of the left-and-right expansion and contraction onto both sides and, hence, halving the movement of the end portions caused by the expansion and contraction. In addition, provision of the support pin 86c and the through-hole 90c permits positioning the films 32 using these as a reference position.

This also applies to the relationship between the lower housing 40 and the upper light source 28a and the relationship between the upper light source 28a and the light guide plate 30.

According to the invention, fixing the center in the left-and-right direction is not essential; the component parts may be suspended using only the long holes and the support pins provided at both ends in the left-and-right direction (or at positions spaced a given distance leftwards and rightwards from the center, respectively).

Although the support pins are erected on the support members of the light guide plate 30 and the through-holes are formed through the films 32 to suspend the films 32 from the light guide plate 30 in the illustrated example, the present invention is not limited to such a configuration; conversely, the pins may be erected on the films 32 and the through-holes may be formed in the support members of the light guide plate (or in the light guide plate). Alternatively, the support pins may be erected directly on the light guide plate 30 without providing the support members.

This also applies to the relationship between the lower housing 40 and the upper light source 28a, the upper light source 28a and the light guide plate 30, and the light guide plate 30 and the lower light source 28b.

The liquid crystal display device 10 is basically configured as described above.

In the backlight unit 20, light emitted by the light sources 28 provided opposite the upper and lower sides of the light guide plate 30 strikes the light entrance planes 30d and 30e of the light guide plate 30. Then, the light admitted through the respective planes is scattered by scatterers contained inside the light guide plate 30 as will be described later in detail as the light travels through the inside of the light guide plate 30 and, directly or after being reflected by the inclined plane 30b or the inclined plane 30c, is emitted through the light exit plane 30a.

Thus, light emitted through the light exit plane 30a of the light guide plate 30 is transmitted through the films 32 and emitted through the light exit opening 24 to illuminate the liquid crystal display panel 12.

The liquid crystal display panel 12 uses the drive unit 14 to control the transmittance for the light according to the position so as to display characters, figures, images, etc. on its surface.

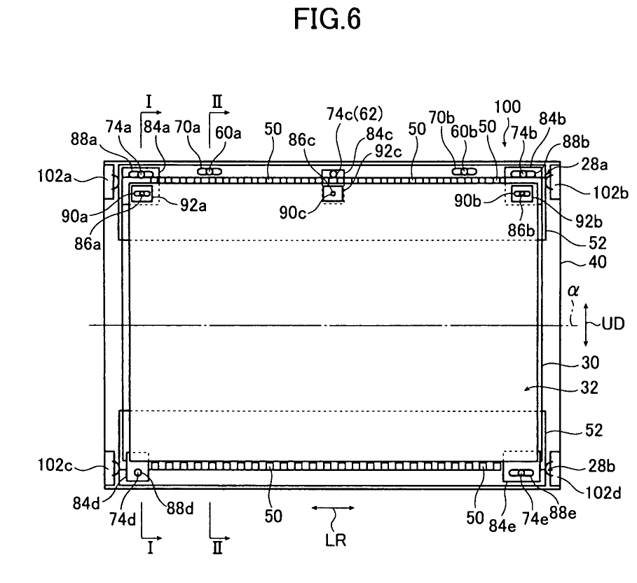

FIG. 6 illustrates the concept of another example of the backlight unit according to the planar lighting device of the invention with the upper housing removed (as in FIG. 2A).

A backlight unit 100 illustrated in FIG. 6 basically has the same configuration as the backlight unit 20 described earlier except for guide members 102 (102a to 102d). In the following, like components will be given like characters, and the description will be focused on the components different between these backlight units.

In the backlight unit 100 illustrated in FIG. 6, a guide member 102a is provided at a position corresponding to one end of the end face in the left-and-right direction of the upper light source 28a, and a guide member 102b is provided at a position corresponding to the other end. Further, a guide member 102c is provided at a position corresponding to one end of the end face in the left-and-right direction of the lower light source 28b, and a guide member 102d is provided at a position corresponding to the other end.

The guide members 102a and 102b for the upper light source 28a may be dispensed with in this embodiment.

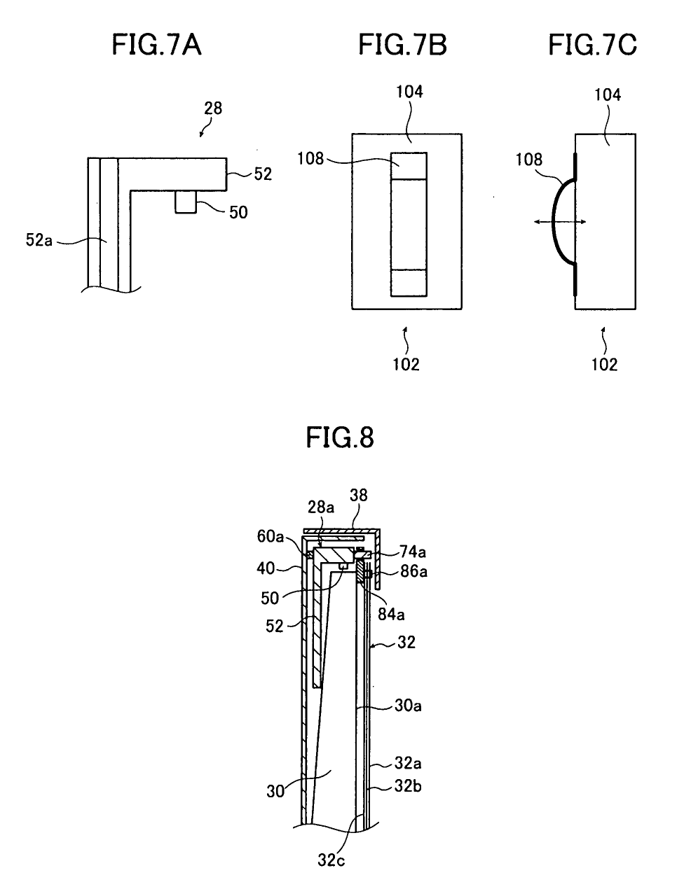

As illustrated in FIG. 7A, a groove 52a is formed so as to extend in the up-and-down direction in each outer end face of the longer side of the L-shaped configuration (i.e., that part extending in the up-and-down direction behind the light guide plate 30) of the light source support 52 forming a part of each light source 28.

FIG. 7B illustrates the concept of the front view of the guide member 102 (as seen from the left-and-right direction); FIG. 7C illustrates the concept of the side view thereof (as seen from the direction of the thickness of the light guide plate 30).

The guide member 102 comprises a base 104 in the form of a rectangular solid and a spring member 108, which is formed by bending a central portion of a long flat plate, with the flat portions thereof secured to the base 104.

The guide member 102 has the spring member 108 extending in the up-and-down direction and is secured to the inner wall of each of the lateral sides of the lower housing 40 with the bent portion of the spring member 108 inserted into the groove 52a of the respective light sources 28. The groove 52a and the spring member 108 are disposed and configured so that the light sources 28 and the guide members 102 can slide in the up-and-down direction relative to each other.

In the backlight unit 100 provided with such guide members 102 according to the illustrated example, the engagement of the groove 52a and the spring member 108 prevents the light guide plate 30 from moving in the thickness direction.

Since the groove 52a and the spring member 108 both extend in the up-and-down direction, the expansion and the contraction of the light guide plate 30 in the up-and-down direction are not hindered. Further, since the spring member 108 has an elasticity in the left-and-right direction as is apparent from its shape, the spring member 108 does not hinder but properly follows the expansion and the contraction of the light guide plate 30 in the left-and-right direction.

As described earlier, the light source support 52 forming a part of each of the light sources 28 has an L-shaped structure having the LED chips 50 arrayed on the shorter side (lower side) of the L-shaped configuration and is disposed so that the surface bearing the LED chips 50 faces the light entrance planes (30d, 30e) of the light guide plate 30 and the longer side of the L-shaped configuration faces the rear side (inclined planes 30b, 30c) of the light guide plate.

The plate portion, the longer side of the L-shaped configuration of the light source support 52, also acts as heat dissipation member for the light sources 28 for releasing heat of the LED chips 50, etc. Therefore, the light source support 52 is preferably formed of a material having a good thermal conductivity.

Accordingly, the length of the longer side of the L-shaped configuration lying in the up-and-down direction preferably extends a maximum possible length without touching the rear side of the light guide plate 30 to obtain a good heat dissipation effect as schematically illustrated in FIG. 8.

Such a configuration permits obtaining a maximum heat dissipation effect and greatly reducing the quantity of or eliminating the need to use grease generally used for heat dissipation in backlight units.

The effect of such a configuration is significantly great where, in particular, the lower light source 28b is also disposed so that it is suspended from the light guide plate 30 as in the illustrated example of the backlight unit 20, the obtained heat dissipation efficiency is poor because the lower light source 28b is not in contact with the housing, etc. However, the configuration wherein the light source support 52 is given the maximum possible length enables an excellent heat dissipation effect to be obtained.

In all the backlight units described above, the two opposite end faces (lateral planes) of the plate-like light guide plate 30 are adapted to be light entrance planes but the invention is not limited to such a configuration; all the four end faces of the plate-like light guide plate 30 may be light entrance planes or only one of the end faces may be a light entrance plane.

The light entrance planes need not necessarily be provided on the longer sides of the light guide plate 30 and may be provided on the shorter sides; the light entrance planes need not necessarily be the upper and lower end faces of the light entrance plane 30 but may be the end faces in the left-and-right direction.

While the light guide plate of the backlight unit according to the illustrated examples has the above-described wedge shape where the thickness gradually increases with the increasing distance from the two light entrance planes, the invention is not limited to such a configuration and permits the use of various light guide plates used in a variety of planar lighting devices.

For example, the light guide plate may be in the form of a flat plate or may have a configuration where the rear side gradually decreases in thickness with the increasing distance from the two light entrance planes. Alternatively, one may use a light guide plate having a configuration having a ridge line located away from the center line α and closer to one of the end faces so that the one end face close to the ridge line is adapted to be a light entrance plane.

While the planar lighting device of the invention has been described above in detail, the present invention is not limited in any manner to the above embodiments and various improvements and modifications may be made without departing from the spirit of the invention.

We claim:

1. A planar lighting device comprising:
a light guide plate comprising a rectangular light exit plane and a light entrance plane existing one side of the light exit plate, the one side being located above an opposite side;
a light source unit disposed opposite the light entrance plane;
a film support means provided with the light guide plate; and
at least one sheet of film suspended from and supported by the film support means and disposed in front of the light exit plane.

2. The planar lighting device of claim 1, wherein the at least one sheet of film is suspended from the film support means using long holes formed in one of the at least one sheet of film and the film support means and oriented in a normal direction normal to an up-and-down direction of the light guide plate and pins formed on the other and inserted into the long holes, respectively.

3. The planar lighting device of claim 1, further comprising a film securing means on a center line of the at least one sheet of film in a normal direction normal to an up-and-down direction for preventing displacement of the at least one sheet of film in the normal direction.

4. The planar lighting device of claim 1, further comprising a light source support means supporting the light source unit, wherein the light source unit is suspended from the light source support means.

5. The planar lighting device of claim 4, wherein the light source unit is suspended from the light source support means using long holes formed in one of the light source unit and the light source support means and oriented in a normal direction normal to an up-and-down direction and pins formed on the other and inserted into the long holes, respectively.

6. The planar lighting device of claim 4, comprising a light source securing means on a center line of the light source unit in a normal direction normal to an up-and-down direction for preventing displacement of the light source unit in the normal direction.

7. The planar lighting device of claim 1, wherein a gap between the light exit plane and one of the at least one sheet of film closest to the light exit plane is in a range of 0.05 mm to 0.2 mm.

8. The planar lighting device of claim 1, wherein the at least one sheet of film has sheets of film, and a gap between adjacent two sheets of film is in a range of 0.05 mm to 0.2 mm.

9. The planar lighting device of claim 1, further comprising another light source unit, wherein
the light guide plate comprises another light entrance plane existing the opposite side of the light exit plate, and
the another light source unit is disposed opposite the another light entrance plane.

10. The planar lighting device of claim 1, wherein a thickness of the light guide plate gradually increases with an increasing distance from the light entrance plane.

11. The planar lighting device of claim 1, wherein the light source unit comprises a plate-like portion disposed so as to cover a plane located opposite from the light exit plane of the light guide plate.

12. The planar lighting device of claim 11, wherein a length of the plate-like portion in a direction away from the light source unit is set to a maximum possible length with the plate-like portion located closest possible to the light exit plane depending upon a shape of the light source unit instead of away from a rear side opposite from the light exit plane of the light guide plate.
